(19) United States
(12) Patent Application Publication
(10) Pub. No.: US 2004/0081097 A1
(43) Pub. Date: Apr. 29, 2004

(54) Method and apparatus for DTX frame detection

(76) Inventors: Francis Dominique, Rockaway, NJ (US); Martin Howard Meyers, Montclair, NJ (US); Leonard Piazzi, Denville, NJ (US); Alexandro Salvarani, Edison, NJ (US)

Correspondence Address: HARNESS, DICKEY & PIERCE, P.L.C., P.O. Box 8910, Reston, VA, 20195, US

(21) Appl. No.: 10/259,753

(22) Filed: Sep. 30, 2002

(51) Int. Cl. H04Q 7/00

(52) U.S. Cl. 370/232

(57) ABSTRACT

A method and apparatus for detecting discontinued transmission (DTX) frames in data frames received over a link or channel, is described, where a DTX frame is a frame that does not carry data and which is transmitted with zero power over the link or channel. The method calculates a data rate of a channel over which data frames are being transmitted, sets a threshold based on the data rate, and determines whether a received data frame is a DTX frame based on the threshold. The apparatus can effectively discriminate a case where a data frame is received as an erasure (e.g., data frame received with errors), and a case where a transmitted data frame is received as a DTX frame.

### BACKGROUND OF THE INVENTION

1. Field of the Invention

The present invention is generally related to communication systems, and more particularly, to an apparatus and method for detecting DTX frames in communication systems.

2. Related Art

Cellular telecommunication systems are typically characterized by a plurality of transceivers in mobile phones and base stations. Each transceiver includes a transmitter and a receiver which communicate with each other via one or more links. A link typically comprises a plurality of communication channels such as signaling channels and traffic channels. Traffic channels are communication channels through which users convey (i.e., transmit and/or receive) user information. Signaling channels are used by the system equipment to convey signaling information used to manage, operate and otherwise control the system. The system equipment, which are typically owned, maintained and operated by a service provider, include various known radio and processing equipment used in communication systems. The system equipment along with user equipment (e.g., cell phone) generate and receive the signaling information.

Communication signals transmitted and received via communication links are often distorted by various anomalies that exist in the communication channels. These channel anomalies cause the signals to be received erroneously. For example, channel anomalies such as Rayleigh fading, frequency translation and phase jitter often cause the signals to lose power, so that a signal is received at a significantly lower power level than it was transmitted. As a result, signals adversely affected by channel anomalies are often received with errors. One way of preventing errors from occurring, or at least to reduce the likelihood of errors occurring, is by applying power control techniques to these communication systems.

Typically, a power control algorithm is performed at a base station. In looking at a signal received from a mobile, if the signal looks weak (e.g., based on detected frame error rate (FER)), the base station sends a command to either increase or decrease mobile station transmit power. For example, a comfortable level of quality in a voice system is possible with a FER of approximately 1%. If FER is much less than (<<) 1%, the mobile station is wasting power, and the power control algorithm located at the base station sends commands to the mobile requesting the mobile to reduce the transmit power. For FER much greater than (>>)1%, the level of quality is degraded and the base station sends a command to the mobile to bring the mobile transmit power up in order to restore quality.

Typically, in order to effect power control at the base station, two loops are utilized, termed “closed-loop power control”: inner loop power control and outer loop power control. In an exemplary CDMA communication system for example, an inner loop power control algorithm (“inner loop”), which may operate at a speed of 800 Hz for example, is used to adjust the power at the transmitter. Thus, a base station measures a received signal to noise ratio (known as E_{b}/Nₜ) and compares the E_{b}/Nₜ value to a threshold. The threshold is used by the inner loop to determine a specified quality of service for power control. If the received E_{b}/Nₜ is too high (e.g., above the threshold), the base station transmitter sends a down power command to the mobile station, and vice versa where E_{b}/Nₜ is too low.

However, a communication path between base station and mobile station is not often line of sight (LOS), and is constantly changing due to the motion of the mobile station, or due to the mobile station's surroundings. As a consequence, path loss between the base station and the mobile station is constantly changing. Under these conditions, the threshold must be adjusted in order to maintain the quality of service of the radio link. The system that performs the function of adjusting the threshold (e.g., setting and adjusting the set point of the threshold) is called the outer loop power control (“outer loop”). Together with the inner loop, the outer loop forms the closed loop power control.

As noted above, the threshold is used to ensure quality of service of the radio link and typically depends on the speed of the mobile and the RF environment in the surroundings of the mobile. The speed in which the outer loop updates (adjusts) the threshold is lower than the inner loop speed. Typical the outer loop operates at a speed of 50 Hz, which is lower than the speed of the inner loop. Thus if the mobile is moving at a low speed, in relation to the base station, the outer loop is effective in adjusting the threshold. However, at high speeds (e.g., in a fading condition environment such as an environment subject to Rayleigh fading) the outer loop is not effective in tracking the changes of the RF conditions. Typically the outer loop is tuned to operate at low FER for efficiency. Thus, a small fraction of all data frames (frames) received by the base station constitute frames that are received with errors. These frames received with errors are called “erasures”. The instance of receiving an erasure triggers the outer loop to increase the threshold (e.g., raise the set point of the threshold). When a frame is received without error (e.g., normally received), the outer loop lowers the threshold slightly in order to decrease its transmitted power and interference to other mobiles.

However, due to a mechanism that is fundamentally different from closed loop power control, the base station can received frames in error, if the mobile decides not to transmit frames at a given time. For example, if the mobile does not have data to send to the base station, but the mobile wants to maintain the connection (e.g., maintain the data channel up) to the base station, the mobile is allowed to maintain the data channel up and set the power of a given transmitted frame to zero. This can happen at any time during the data transmission. This condition, where the mobile station actually transmits a frame, but the frame contains no data and has its power (e.g., gain) set to be zero, is called a Discontinued Transmission (DTX) mode. DTX mode can be initiated by the mobile at any time, without informing the base station (e.g., the base station has no knowledge that the mobile station has shifted to DTX mode). Accordingly, frames that do not carry data and which are transmitted with zero power are called “DTX frames”. The mobile station transmits DTX frames to the base station to avoid bringing down the connection (data channel) when the data traffic is bursty. For example, data in cellular communications is typically transmitted in bursts (e.g., many consecutive frames of data transmitted, followed by silence, followed by another “burst” of data, etc.).

To the base station, both DTX frames and erasures exhibit similar signal strength around the noise level. Thus, it is difficult for a base station receiver to distinguish between DTX frames and erasures. The base station must perform some type of efficient blind detection in order to efficiently distinguish DTX frames from erasures.

Accordingly, a high efficiency in distinguishing between DTX frames from erasures is needed in order to operate the power control outer loop at high performance. Received frames that are incorrectly identified as DTX frames by a receiver prevent the outer loop from increasing the threshold, which potentially may cause additional erasures. Further, received frames that are incorrectly identified as erasures cause the outer loop to unnecessarily increase the set point of the threshold increasing interference and ultimately decreasing the call capacity of the system.

The ideal response of the closed-loop power control algorithm when processing DTX frames is fundamentally different from a response to processing erasures. For example, if a DTX frame is received, the power control outer loop should freeze the threshold (e.g., maintain the threshold at a given set point) for the duration of the DTX. However, if a frame undergoes a channel fade and an erasure is actually received, the outer loop should increase the threshold in order to maintain quality of service of the link. Since the response of the outer loop depends on the detected state of the received frames, DTX detection by the receiver must be reliable.

DTX frames are detected at the receiver end. In the forward link, DTX detection is done at the mobile station, while in the reverse link, DTX detection is performed at the base station. Typically, DTX detection is accomplished using a technique that compares a metric, such as a measured traffic energy value of the channel or symbol error rate (SER) value of the transmitting channel, against the threshold. If the metric is lower than the threshold, then the frame is declared DTX; otherwise the frame is an erasure. However, the reliability of this technique is susceptible to noise fluctuations that cause detection errors. Further, this susceptibility increases as the transmitted signal becomes weakened.

To combat this, designers of conventional DTX detectors attempt to select a suitable threshold, but this has proven difficult. For example, choosing a low threshold would increase a rate of false bad frame alarms (e.g., a DTX frame is detected as an erasure.) If a high threshold is selected, the rate of false DTX detection increases (e.g., transmitted frames received in error are more likely to be detected as DTX frames than as erasures). In an extreme case of a deep fade, if a high threshold is set, this may lead to a “deadlocked” state created by an inability to increase transmit power. This is because the power control algorithm(s) (e.g., outer-loop) will freeze the set point of the threshold, such that the receiver does not increase its transmit power. So long as a channel remains in a fading condition, the outer loop is essentially “broken”, i.e., is not capable of increasing the power when needed, and quality of service of the link becomes increasingly degraded because an unacceptable amount of data being transmitted is received in error by the receiver.

Since the misidentification of DTX frames causes errors in the operation of the outer loop and degradation of system performance (data throughput and call capacity) the detection of DTX frames must be reliable. As noted above, current DTX detectors utilize a threshold, which may be termed a “DTX threshold” that is set at a single, specified value by a suitable processor such as an Application Specific Integrated Circuit (ASIC). Given the ASIC's constraints, a channel (for example, a traffic channel) transmitting data at a 19.2 kbps data rate uses the same DTX threshold as a channel transmitting at a data rate of 153.6 kbps, for example. Since the DTX reliability depends on the value of the DTX threshold, and as an optimum DTX threshold is a function of the data rate, a tradeoff must be found when a common DTX threshold is used for all data rates. As a consequence, system performance is degraded because a fixed value of the DTX threshold does not provide best performance for all data rates.

### SUMMARY OF THE INVENTION

The present invention provides a method and apparatus for detecting frames that are transmitted with no data and at zero power (discontinued transmission (DTX frames) and distinguishing them from frames that are transmitted but received with errors (erasures). In an exemplary embodiment, the method determines a DTX threshold which is a function of the data rate of a transmitting channel. The DTX threshold is used by a DTX detector to decide if a frame received with bad quality is DTX frame, or an erasure.

### BRIEF DESCRIPTION OF THE DRAWINGS

The present invention will become more fully understood from the detailed description given hereinbelow and the accompanying drawings, wherein like elements are represented by like reference numerals, which are given by way of illustration only and thus are not limitative of the present invention and wherein:

FIG. 1 is a simplified block diagram of a receiver incorporating a DTX detection capability in accordance with an exemplary embodiment of the present invention; and

FIG. 2 is a flow diagram illustrating the method in accordance with an exemplary embodiment of the invention.

### DETAILED DESCRIPTION

Although the principles of the invention are particularly well-suited for wireless communications systems based on the well-known IS 2000 or CDMA 2000 standards, and will be described in this exemplary context, it should be noted that the embodiments shown and described herein are meant to be illustrative only and not limiting in any way. For example, the present invention is also applicable to the well-known High Speed Downlink Packet Access (HSDPA) specification in the Universal Mobile Telecommunication System (UMTS) standard. As such, various modifications will be apparent to those skilled in the art for application to other transmission systems and are contemplated by the teachings herein.

In accordance with the method and apparatus of the present invention, a DTX threshold is set based on the data rate of a channel (e.g., traffic channel) in order to improve reliability of DTX detection. In this way, a DTX threshold may be optimized for each individual data rate and radio configuration of the channel.

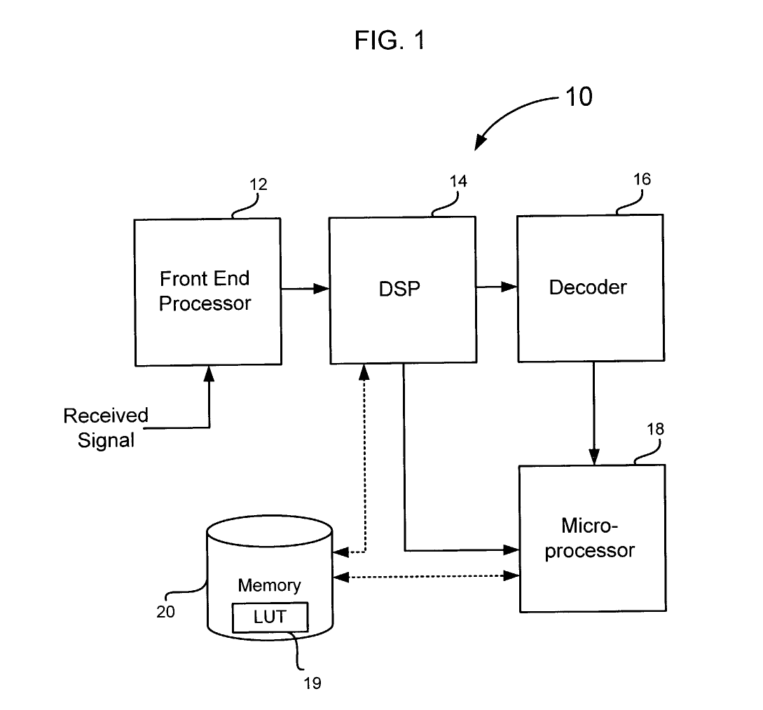

FIG. 1 is a simplified block diagram of a receiver incorporating a DTX detector in accordance with the present invention. In this embodiment, the method and apparatus is described from the aspect of the reverse link, i.e., DTX frame detection is performed at a base station receiver. However, the method and apparatus described herein are applicable to the forward link (e.g., DTX frame detection at a mobile station receiver). Accordingly, in FIG. 1, receiver 10 may be a receiver in a base station of a cellular communication system, for example. The receiver 10 includes a base station modem (BSM) chip level processing stage 12, which may include finger front end pseudo-noise (PN) processing. After the PN code is removed from each finger (e.g., each signal component) of a signal that is transmitted over a channel or link. The received signal contains one or more frames, where “frame” refers to a data frame that is carrying data over the channel between a transmitter and receiver). The received signal is processed by a symbol level processor 14. In an embodiment, this could may be implemented as a digital signal processor (DSP) or alternately as an ASIC. The DSP 14 converts the symbols into data bits. The data bits are then output to a decoder 16, which in an illustrative code division multiple access (CDMA) system, performs speech (e.g., Viterbi) or data decoding.

The DSP 14 also calculates one or more metrics used for identifying DTX frames. The metrics may be embodied as a measured traffic energy of the channel value or symbol error rate (SER) value of the transmitting channel, for example, it being understood that the metric could be any other measurable or calculated parameter of the transmitting channel. A metric is calculated for every frame received over a channel. The metrics are output to a microprocessor 18.

Additionally, DSP 14 determines the data rate for each channel that is transmitting data frames. A “best data rate” for a particular channel is to be utilized in setting a DTX threshold for that particular channel, based on a determined best data rate. For example, the DSP 14 utilizes an algorithm to determine the best data rate for a given channel based on the conditions of the transmitting channel as compared to stored parameters (e.g., predetermined data rates) that are known for that particular channel. In the specific case of the CDMA-2000 standard, for example, the data rate of the channel is known by receiver 10 before the channel is assigned, and is maintained for the duration of the transmission. The base station updates the receiver 10 before a change of data rate is performed. In this way, the DSP 14 does not have to estimate the data rate after decoding. The present invention is not limited to the above method of determining a best data rate; a blind rate detection method may be performed in the case where the data rate is not signaled ahead of time by the base station.

DSP 14 may be constructed with an ASIC (application specific integrated circuit) that contains, for example, a general purpose R3000A MIPS RISC core, with sufficient on-chip instruction cache and data cache memory. Furthermore, DSP 14 may integrate system peripherals such as interrupt, timer, and memory controllers on-chip, including ROM, SDRAM, DMA controllers; a packet processor, crypto-logic, PCI compliant PC port, and parallel inputs and outputs, for example.

Microprocessor 18, which may also be embodied as part of an ASIC, or as a singular microprocessor chip, sets a threshold based on the best data rate received from DSP 14 for a traffic channel. For example, DTX thresholds may be calculated for a number of different data rates in advance, and stored in a suitable storage media such as a look-up table (LUT) 19 of a non-volatile memory 20 operatively connected to DSP 14 and/or microprocessor 18, as is known (see dotted-line in FIG. 1). Once a best data rate is known and received from DSP 14, microprocessor 18 may reference LUT 19 to determine which DTX threshold for a predetermined data rate is closest to the actual data rate received from DSP 14 for that traffic channel.

Accordingly, the selected DTX threshold is compared against the metric calculated at DSP 14 to determine whether or not a data frame corresponding to that metric is a DTX frame, or a frame that was transmitted with error (e.g., an erasure). Alternatively, microprocessor 18 may contain a particular algorithm or separate ASIC which performs the threshold calculation based on the data rate. For example, the algorithm may provide the flexibility to read the value of the DTX threshold from an external register (e.g., LUT 19) that is set in a call-by-call basis by a software application/ASIC running the algorithm, depending on the data rate. Alternatively, the DTX thresholds may be estimated through link level simulation results or through field measurements.

The implementation shown in FIG. 1 may include storage media operatively connected to, or embodied within each of the processors 12, 14 and 18. The memory 20 may be embodied as ROM, RAM, SDRRAM or other non-volatile memory device, and may store parameters that are part of a register or LUT which is accessible by one or more of the processors. Further, multiple memories may be dispensed with altogether or consolidated within a singular memory device.

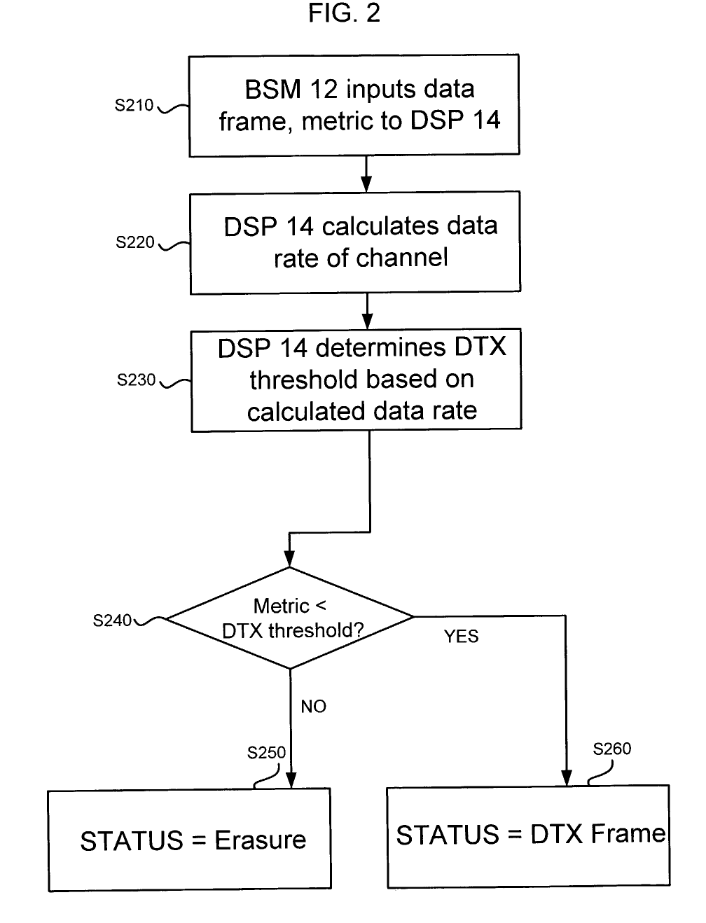

FIG. 2 is a flow chart illustrating a method in accordance with an exemplary embodiment of the invention. Referring now to FIG. 2, each finger (component) of the received signal together with a corresponding calculated metric (e.g., traffic energy metric or symbol error rate (SER) metric for that channel) are sent from BSM chip level processing stage 12 to DSP 14 (Step S210). DSP 14 calculates the best data rate of the channel transmitting the data frames in a Step S220. For example, the best data rate may be determined via blind rate detection method. In a blind detection method, all data rate hypothesis are tried, and the data rate of the best metric is the winner. Alternatively, the best data rate may be known before the channel is assigned, as is the case in CDMA-2000 for a shared control channel (SCH) and downlink control channel (DCCH).

The calculated data rate is used by DSP 14 to set a DTX threshold (Step S230) based on the computed data rate in Step S230. In an alternative embodiment, microprocessor 18 may determine the threshold based on the computed data received form DSP 14, or an ASIC may be provided for determining the DTX threshold based on a best data rate input to the ASIC from DSP 14 or microprocessor 18.

DSP 14 compares (Step S240) the metric for each frame received from a transmitting channel against the DTX threshold determined from the best data rate of that channel and sends a result to microprocessor 18. If the metric value is greater than or equal to (≧) the DTX threshold (e.g., the output of Step S240 is NO), DSP 14 determines that a bad frame has been transmitted, and outputs status (erasure) (Step S250) to microprocessor 18. However, if the metric is less than (<) the DTX threshold (e.g., the output of Step S240 is YES) a DTX frame is declared as the status (Step S260). Accordingly, discrimination as to whether a transmitted frame is a DTX frame, or simply an erasure (bad frame transmitted with error), is determined with greater accuracy, since each individual data rate is associated with a unique DTX threshold.

The method and apparatus of the invention provide greater DTX reliability by making a DTX threshold dependent on data rate of a traffic channel, so that a condition required to declare a frame as a DTX frame is more restrictive. In this way, the value of the DTX threshold is optimized separately for each data rate. The invention is applicable to both forward and reverse links, and benefit both base station and mobile station performance.

The invention being thus described, it will be obvious that the same may be varied in many ways, for example, the logical blocks in FIGS. 1 and 2 may be implemented in hardware and/or software. The hardware/software implementations may include a combination of processor(s) and article(s) of manufacture. The article(s) of manufacture may further include storage media, computer-readable media having code portions thereon that are read by a processor to perform the method, and executable computer program(s). The executable computer program(s) may include instructions to perform the described operations and the method. The computer executable(s) may also be provided as part of externally supplied propagated signals. Such variations are not to be regarded as a departure and scope of the invention, and all such modifications as would be obvious to one skilled in the art are intended to be included within the scope of the following claims.

What is claimed:

1. A method of detecting discontinued transmission (DTX) frames in data frames received over a link or channel, the method comprising the steps of:
calculating a data rate of a channel over which data frames are being transmitted;
setting a threshold based on the data rate; and
determining whether a received data frame is a DTX frame based on the threshold.

2. The method of claim 1, wherein said step of determining further comprises:
comparing a metric of the received data frame against the threshold, and
determining that the received data frame is an erasure if the metric is less than the threshold.

3. The method of claim 1, wherein said step of determining further comprises:
comparing a metric of the received data frame against the threshold, and
determining that the received data frame is a DTX frame if the metric is greater than or equal to the threshold.

4. The method of claim 1, further comprising:
calculating a metric from one of a traffic energy value or symbol error rate (SER) of the received data frame,
wherein said step of determining further comprises comparing said metric against the threshold.

5. The method of claim 4, wherein said determining step further comprises
determining that the received data frame is a transmitted frame received with error if said comparing step determines that the metric is less than the threshold.

6. The method of claim 4, wherein said determining step further comprises
determining that the received data frame is an erasure if said comparing step determines that the metric is greater than or equal to the threshold, wherein an erasure is a transmitted data frame that is received with errors.

7. The method of claim 1, wherein said channel is a CDMA traffic channel.

8. The method of claim 1, wherein the data frames are received over one of a forward link or reverse link.

9. A method of setting a threshold value to detect discontinued transmission (DTX) frames in data frames received over a link or channel, the method comprising the steps of:
calculating a data rate of a channel over which data frames are being transmitted;
setting the threshold value based on the data rate.

10. The method of claim 9, wherein a data frame is determined to be a DTX frame based on the set threshold value

11. The method of claim 9, further comprising:
updating said threshold value as calculated data rate over the transmitting channel changes, thereby optimizing the threshold for individual data rates.

12. The method of claim 9, further comprising:
comparing a metric of a received data frame against the set threshold value, wherein the received data frame is determined to be an erasure if the metric is less than the set threshold value.

13. The method of claim 9, wherein said step of determining further comprises:
comparing a metric of the received data frame against the set threshold value, wherein the received data frame is determined to be a DTX frame if the metric is greater than or equal to the set threshold value.

14. The method of claim 9, further comprising:
calculating a metric from one of a traffic energy value or symbol error rate (SER) of a received data frame; and
comparing said metric against the set threshold value.

15. The method of claim 14,
wherein a received data frame is determined to be an erasure, if said comparing step determines that the metric is less than the set threshold value, and
wherein an erasure is a transmitted data frame received with errors.

16. The method of claim 14, wherein a received data frame is determined to be a DTX frame if said comparing step determines that the metric is greater than or equal to the threshold value.

17. The method of claim 9, wherein the data frames are received over one of a forward link or reverse link.

18. An apparatus for detecting discontinued transmission (DTX) frames in data frames received over a link or channel, comprising:
means for calculating a data rate of a channel over which data frames are being transmitted;
means for setting a threshold based on the data rate; and
means for determining whether a received data frame is a DTX frame based on the threshold.

19. The apparatus of claim 18,
wherein said means for determining compares a metric of the received data frame against the set threshold value, and determines that the received data frame is an erasure if the metric is less than the threshold.

20. The apparatus of claim 18,
wherein said means for determining compares a metric of the received data frame against the set threshold value, and determines that the received data frame is a DTX frame, if the metric is greater than or equal to the set threshold value.

21. The apparatus of claim 18, further comprising:
means for computing a metric from one of a traffic energy value or symbol error rate (SER) of a received data frame,
wherein said means for determining compares said metric against the set threshold value.

22. The apparatus of claim 21,
wherein said means for determining establishes that the received data frame is an erasure if the metric is less than the set threshold value, and
wherein an erasure is a transmitted data frame received with error.

23. The apparatus of claim 21, wherein said means for determining establishes that the received data frame is a DTX frame, if the metric is greater than or equal to the set threshold value.

24. The apparatus of claim 18, wherein the data frames are received over one of a forward link or reverse link.
